(19) United States
(12) Patent Application Publication
(10) Pub. No.: US 2008/0252974 A1
(43) Pub. Date: Oct. 16, 2008

(54) Elliptically Polarizing Plate, Optical Film and Image Display

(75) Inventors: Kazunori Futamura, Osaka (JP); Minoru Miyatake, Osaka (JP); Yuuji Saiki, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Nitto Denko Corporation, Osaka (JP)

(21) Appl. No.: 10/594,384

(22) PCT Filed: Mar. 17, 2005
(86) PCT No.: PCT/JP2005/004801

§ 371 Date: Sep. 27, 2006

(30) Foreign Application Priority Data
Mar. 29, 2004 (JP) 2004-095533

(51) Int. Cl. G02B 5/30; G02F 1/13

(52) U.S. Cl. 359/490; 349/194

(57) ABSTRACT

An elliptical polarization plate includes: a scatter/two-color absorption composite type polarizer formed by a film of such a structure that minute areas are scattered in a matrix formed by a translucent resin containing iodine-based light absorber; a transparent support body; and discotic liquid crystal or nematic liquid crystal having an optically anisotropic layer where the optical axis of the liquid crystal molecule is inclined from the transparent support body surface. The elliptical polarization plate has a wide field of view, a high contrast, a high transparency, and a high polarization degree while suppressing the irregularities of the transparency when performing black display.

### TECHNICAL FIELD

The invention relates to an elliptically polarizing plate with an optical compensation function. The invention also relates to an optical film using the elliptically polarizing plate. The invention further relates to image displays, such as liquid crystal displays, organic EL displays, CRTs, and PDPs, using the elliptically polarizing plate or the optical film.

### BACKGROUND ART

Liquid crystal display are rapidly developing in market, such as in clocks and watches, cellular phones, PDAs, notebook-sized personal computers, and monitor for personal computers, DVD players, TVs, etc. In the liquid crystal display, visualization is realized based on a variation of polarization state by switching of a liquid crystal, where polarizers are used based on a display principle thereof. Particularly, usage for TV etc. increasingly requires display with high luminance and high contrast, polarizers having higher brightness (high transmittance) and higher contrast (high polarization degree) are being developed and introduced.

The currently mainstream type of general liquid crystal displays is a TFT-LCD using a TN liquid crystal. This type has the advantages of a high response speed and a capability of producing high contrast. However, if displays on TN liquid crystal panels are viewed at angles oblique to the normal direction, their contrast can be significant low, or tone reversal, an event in which the tone of displays is inverted, or the like can take place. Thus, TN liquid crystals have very narrow viewing angle characteristics. On the other hand, applications such as large PC monitors and large screen televisions should satisfy certain requirements such as high contrast, wide viewing angle, and little fluctuation in display color in spite of viewing angle. Thus, TN mode TFT-LCDs for use in such applications must have a retardation film for compensating for viewing angle.

Conventionally, stretched birefringent polymer films have been used as the retardation film. Recently, it has been proposed that the optical compensation sheet made of the stretched birefringent film is replaced with another optical compensation sheet having an optically anisotropic layer formed of a liquid crystalline molecule on a transparent support. Since liquid crystalline molecules can have various orientation configurations, the use of liquid crystalline molecules has enabled the achievement of certain optical properties that had not been achieved with conventional stretched birefringent polymer films.

For example, one of the proposed retardation films for viewing angle compensation is Wide View Film manufactured by Fuji Photo Film Co., Ltd., which uses a discotic liquid crystal with negative refractive index anisotropy (Japanese Patent Application Laid-Open (JP-A) No. 08-95032 and Japanese Patent No. 2767382). The main purpose of this retardation film is to improve viewing angle properties in a state where a certain voltage for black viewing is applied. Namely, in a state where a certain voltage is applied, a liquid crystal molecule in a liquid crystal cell shows positive refractive index anisotropy with an optical axis tilted with respect to a glass substrate. In order to compensate for the retardation caused by this refractive index anisotropy, the retardation film uses a liquid crystalline molecule having an optical axis tilted with respect to the film normal direction and having negative refractive index anisotropy.

Another proposed retardation film for viewing angle compensation is NH Film manufactured by NIPPON OIL CORPORATION, which uses a nematic liquid crystal with positive refractive index anisotropy (Japanese Patent No. 3399705 and No. 3445689). The main purpose of this film is to compensate for halftone display state, and it is a retardation film using a liquid crystalline molecule having an optical axis tilted with respect to the film normal direction and having positive refractive index anisotropy.

There is also proposed a retardation film which laminating an optical compensation layer, a nematic liquid crystalline molecule is used, with its optical axis tilted with respect to the film normal direction, and another optical compensation layer having positive uniaxiality and having an optical axis in the film plane in such a manner that the their main refractive index directions are perpendicular to each other, for compensating for viewing angle for display contrast and compensating for halftone display state (JP-A No. 07-306406, No. 07-35924, No. 10-123506).

Dichroic absorbing polarizers such as iodine based polarizers comprising stretched polyvinyl alcohol on which iodine is adsorbed are widely used, because they have high transmittances and high degrees of polarization (JP-A No. 2001-296427). However, iodine based polarizers have relatively low degrees of polarization on the short wavelength side and thus have a problem with hue, such as blue dropout on the short wavelength side during black viewing and yellowing during white viewing.

Iodine based polarizers can also easily suffer from uneven iodine adsorption. Such unevenness can be detected as uneven transmittance particularly during black viewing and cause the problem of a reduction in visibility. In order to solve the problem, for example, there are proposed a method in which the amount of iodine adsorbed on iodine based polarizer is increased such that the transmittance for black viewing does not exceed the lower limit of sensitivity of human eyes and a method employing a stretching process that is resistant to causing unevenness itself. However, the former method has a problem in which the transmittance for white viewing is also reduced in the same way as the transmittance for black viewing so that display itself becomes dark. The latter method also has a problem in which a certain process has to be entirely replaced so that the productivity can be reduced.

In particular, an elliptically polarizing plate laminated with the above-mentioned retardation film for viewing angle compensation have a higher transmittance and a higher degree of polarization and can cause a problem in which the above-mentioned unevenness is more significantly observed.

Specifically, if the elliptically polarizing plate laminated with the retardation film for viewing angle compensation is used, an anisotropic scattering effect can occur even at a perpendicular viewing angle so that obliquely incident light can be scattered in a direction perpendicular to the surface, light can leak over the surface when black is displayed, and a reduction in contrast can be feared. Thus, a laminated TN-TFT panel with such incomplete optical compensation can only fail to produce satisfactory image display with good visibility but also exhibit visibility lower than that in the case where a general polarizing plate is used.

### DISCLOSURE OF INVENTION

It is an object of the invention to provide an elliptically polarizing plate which includes a laminate of an absorbing polarizer and a retardation film for viewing angle compensation and has a wide viewing angle, a high contrast, a high transmittance, and a high degree of polarization and in which uneven transmittance can be suppressed when black viewing is displayed.

It is another object of the invention to provide an optical film using at least one piece of the elliptically polarizing plate and to provide an image display using the elliptically polarizing plate or the optical film.

As a result of examination wholeheartedly performed by the present inventors that the above-mentioned subject should be solved, it was found out that the above-mentioned purpose might be attained using an elliptically polarizing plates shown below, leading to completion of this invention.

That is, this invention relates to an elliptically polarizing plate comprising:

a complex type scattering-dichroic absorbing polarizer including a film that has a structure having a minute domain dispersed in a matrix formed of an optically-transparent water-soluble resin including an iodine based light absorbing material;

a transparent support; and

an optically anisotropic layer comprising a discotic or nematic liquid crystal, wherein the molecule of the liquid crystal has an optical axis tilted with respect to a surface of the transparent support.

The minute domain of the complex type absorbing polarizer is preferably formed by an oriented birefringent material. The above-mentioned birefringent material preferably shows liquid crystallinity at least in orientation processing step.

The above-mentioned polarizer of this invention has an iodine based polarizer formed by an optically-transparent water-soluble resin and an iodine based light absorbing material as a matrix, and has dispersed minute domains in the above-mentioned matrix. Minute domains are preferably formed by oriented materials having birefringence, and particularly minute domains are formed preferably with materials showing liquid crystallinity. Thus, in addition to function of absorption dichroism by iodine based light absorbing materials, characteristics of having function of scattering anisotropy improve polarization performance according to synergistic effect of the two functions, and as a result a polarizer having both of transmittance and polarization degree, and excellent visibility may be provided.

Scattering performance of anisotropic scattering originates in refractive index difference between matrixes and minute domains. For example, if materials forming minute domains are liquid crystalline materials, since they have higher wavelength dispersion of Δn compared with optically-transparent water-soluble resins as a matrix, a refractive index difference in scattering axis becomes larger in shorter wavelength side, and, as a result, it provides more amounts of scattering in shorter wavelength. Accordingly, an improving effect of large polarization performance is realized in shorter wavelengths, compensating a relative low level of polarization performance of an iodine based polarizer in a side of shorter wavelength, and thus a polarizer having high polarization and neutral hue may be realized.

A combination of the complex type scattering-dichroic absorbing polarizer, the transparent support and the above-mentioned optically anisotropic layer provides an elliptically polarizing plate with optical compensation function that has a high transmittance and a high degree of polarization, can produce high contrast in a wide viewing angle range, and can suppress unevenness in transmittance during black viewing.

In the above-mentioned elliptically polarizing plate, it is preferable that the minute domains of the complex type absorbing polarizer have a birefringence of 0.02 or more. In materials used for minute domains, in the view point of gaining larger anisotropic scattering function, materials having the above-mentioned birefringence may be preferably used.

In the above-mentioned elliptically polarizing plate, in a refractive index difference between the birefringent material forming the minute domains and the optically-transparent water-soluble resin of the complex type absorbing polarizer in each optical axis direction, a refractive index difference (Δn¹) in direction of axis showing a maximum is 0.03 or more, and a refractive index difference (Δn²) between the Δn¹ direction and a direction of axes of two directions perpendicular to the Δn¹ direction is 50% or less of the Δn¹

Control of the above-mentioned refractive index difference (Δn¹) and (Δn²) in each optical axis direction into the above-mentioned range may provide a scattering anisotropic film having function being able to selectively scatter only linearly polarized light in the Δn¹ direction, as is submitted in U.S. Pat. No. 2,123,902 specification. That is, on one hand, having a large refractive index difference in the Δn¹ direction, it may scatter linearly polarized light, and on the other hand, having a small refractive index difference in the Δn² direction, and it may transmit linearly polarized light. Moreover, refractive index differences (Δn²) in the directions of axes of two directions perpendicular to the Δn¹ direction are preferably equal.

In order to obtain high scattering anisotropy, a refractive index difference (Δn¹) in a Δn¹ direction is set 0.03 or more, preferably 0.05 or more, and still preferably 0.10 or more. A refractive index difference (Δn²) in two directions perpendicular to the Δn¹ direction is 50% or less of the above-mentioned Δn¹, and preferably 30% or less.

In iodine based light absorbing material in the above-mentioned elliptically polarizing plate, a an absorption axis of the iodine based light absorbing material of the complex type absorbing polarizer is preferably orientated in the Δn¹ direction.

The iodine based light absorbing material in a matrix is orientated so that an absorption axis of the material may become parallel to the above-mentioned Δn¹ direction, and thereby linearly polarized light in the Δn¹ direction as a scattering polarizing direction may be selectively absorbed. As a result, on one hand, a linearly polarized light component of incident light in a Δn² direction is not scattered or hardly absorbed by the iodine based light absorbing material as in conventional iodine based polarizers without anisotropic scattering performance. On the other hand, a linearly polarized light component in the Δn¹ direction is scattered, and is absorbed by the iodine based light absorbing material. Usually, absorption is determined by an absorption coefficient and a thickness. In such a case, scattering of light greatly lengthens an optical path length compared with a case where scattering is not given. As a result, polarized component in the Δn¹ direction is more absorbed as compared with a case in conventional iodine based polarizers. That is, higher polarization degrees may be attained with same transmittances.

Descriptions for ideal models will, hereinafter, be given. Two main transmittances usually used for linear polarizer (a first main transmittance k₁ (a maximum transmission direction=linearly polarized light transmittance in a Δn² direction), a second main transmittance k₂ (a minimum transmission direction=linearly polarized light transmittance in a Δn¹ direction)) are, hereinafter, used to give discussion.

In commercially available iodine based polarizers, when iodine based light absorbing materials are oriented in one direction, a parallel transmittance and a polarization degree may be represented as follows, respectively:

parallel transmittance=0.5×((k₁)²+(k₂)²) and

polarization degree=(k₁−k₂)/(k₁+k₂).

On the other hand, when it is assumed that, in a polarizer of this invention, a polarized light in a Δn¹ direction is scattered and an average optical path length is increased by a factor of α (>1), and depolarization by scattering may be ignored, main transmittances in this case may be represented as k₁ and k₂′=10^{x} (where, x is α log k₂), respectively

That is, a parallel transmittance in this case and the polarization degree are represented as follows:

parallel transmittance=0.5×((k₁)²+(k₂′)²) and

polarization degree=(k₁−k₂′)/(k₁+k₂′).

When a polarizer of this invention is prepared by a same condition (an amount of dyeing and production procedure are same) as in commercially available iodine based polarizers (parallel transmittance 0.385, polarization degree 0.965: k₁=0.877, k₂=0.016), on calculation, when α is 2 times, k₂ becomes small reaching 0.0003, and as result, a polarization degree improves up to 0.999, while a parallel transmittance is maintained as 0.385. The above-mentioned result is on calculation, and function may decrease a little by effect of depolarization caused by scattering, surface reflection, backscattering, etc. As the above-mentioned equations show, higher value α may give better results and higher dichroic ratio of the iodine based light absorbing material may provide higher function. In order to obtain higher value α, a highest possible scattering anisotropy function may be realized and polarized light in a Δn¹ direction may just be selectively and strongly scattered. Besides, less backscattering is preferable, and a ratio of backscattering strength to incident light strength is preferably 30% or less, and more preferably 20% or less.

In the above-mentioned elliptically polarizing plate, the films used as the complex type absorbing polarizer manufactured by stretching may suitably be used.

In the above-mentioned elliptically polarizing plate, minute domains of the complex type absorbing polarizer preferably have a length in a Δn² direction of 0.05 to 500 μm.

In order to scatter strongly linearly polarized light having a plane of vibration in a Δn¹ direction in wavelengths of visible light band, dispersed minute domains have a length controlled to 0.05 to 500 μm in a Δn² direction, and preferably controlled to 0.5 to 100 μm. When the length in the Δn² direction of the minute domains is too short a compared with wavelengths, scattering may not fully provided. On the other hand, when the length in the Δn² direction of the minute domains is too long, there is a possibility that a problem of decrease in film strength or of liquid crystalline material forming minute domains not fully oriented in the minute domains may arise.

In the above-mentioned elliptically polarizing plate, the complex type absorbing polarizer, the transparent support and the optically anisotropic layer comprising a discotic or nematic liquid crystal whose molecule has an optical axis tilted with respect to a surface of the transparent support are preferably laminated in this order.

The complex type absorbing polarizer, the transparent support and the optically anisotropic layer comprising a discotic or nematic liquid crystal whose molecule has an optical axis tilted with respect to a surface of the transparent support are preferably laminated and fixed with a transparent acrylic pressure-sensitive adhesive. If the complex type absorbing polarizer, the transparent support and the optically anisotropic layer are only layered on each other, it would be difficult to form a solid laminate with no space therebetween. Thus, they are preferably bonded together with an optically-transparent adhesive or pressure-sensitive adhesive. The pressure-sensitive adhesive is preferred in terms of convenience of bonding, and an acrylic pressure-sensitive adhesive is preferred in terms of transparency, adhesive properties, weather resistance, and heat resistance.

In the above-mentioned elliptically polarizing plate, with regard to the complex type absorbing polarizer, a transmittance to a linearly polarized light in a transmission direction is 80% or more, a haze value is 5% or less, and a haze value to a linearly polarized light in an absorption direction is 30% or more.

A complex type absorbing polarizer of this invention having the above-mentioned transmittance and haze value has a high transmittance and excellent visibility for linearly polarized light in a transmission direction, and has strong optical diffusibility for linearly polarized light in an absorption direction. Therefore, without sacrificing other optical properties and using a simple method, it may demonstrate a high transmittance and a high polarization degree, and may control unevenness of the transmittance in the case of black viewing.

As a complex type absorbing polarizer of this invention, a polarizer is preferable that has as high as possible transmittance to linearly polarized light in a transmission direction, that is, linearly polarized light in a direction perpendicular to a direction of maximal absorption of the above-mentioned iodine based light absorbing material, and that has 80% or more of light transmittance when an optical intensity of incident linearly polarized light is set to 100. The light transmittance is preferably 85% or more, and still preferably 88% or more. Here, a light transmittance is equivalent to a value Y calculated from a spectral transmittance in 380 nm to 780 nm measured using a spectrophotometer with an integrating sphere based on CIE 1931 XYZ standard calorimetric system. In addition, since about 8% to 10% is reflected by an air interface on a front surface and rear surface of a polarizer, an ideal limit is a value in which a part for this surface reflection is deducted from 100%.

It is desirable that a complex type absorbing polarizer does not scatter linearly polarized light in a transmission direction in the view point of obtaining clear visibility of a display image. Accordingly, the polarizer preferably has 5% or less of haze value to the linearly polarized light in the transmission direction, more preferably 3% or less. On the other hand, in the view point of covering unevenness by a local transmittance variation by scattering, a polarizer desirably scatters strongly linearly polarized light in a absorption direction, that is, linearly polarized light in a direction for a maximal absorption of the above-mentioned iodine based light absorbing material. Accordingly, a haze value to the linearly polarized light in the absorption direction is preferably 30% or more, more preferably 40% or more, and still more preferably 50% or more. In addition, the haze value here is measured based on JIS K 7136 (how to obtain a haze of plastics-transparent material).

The above-mentioned optical properties are obtained by compounding a function of scattering anisotropy with a function of an absorption dichroism of the polarizer. As is indicated in U.S. Pat. No. 2,123,902 specification, Japanese Patent Laid-Open No. 9-274108, and Japanese Patent Laid-Open No. 9-297204, same characteristics may probably be attained also in a way that a scattering anisotropic film having a function to selectively scatter only linearly polarized light, and a dichroism absorption type polarizer are superimposed in an axial arrangement so that an axis providing a greatest scattering and an axis providing a greatest absorption may be parallel to each other. These methods, however, require necessity for separate formation of a scattering anisotropic film, have a problem of precision in axial joint in case of superposition, and furthermore, a simple superposition method does not provide increase in effect of the above-mentioned optical path length of the polarized light absorbed as is expected, and as a result, the method cannot easily attain a high transmission and a high polarization degree.

This invention also relates to an optical film comprising at least one of the above-mentioned elliptically polarizing plate.

This invention further relates to an image display comprising the above-mentioned elliptically polarizing plate or the above-mentioned optical film.

### BRIEF DESCRIPTION OF DRAWING

FIG. 1 is a schematic diagram showing an example of the polarizer according to the invention; and

FIG. 2 is a graph showing the polarized absorption spectra of the polarizers in Example 1 and Comparative Example 1.

### BEST MODE FOR CARRYING OUT THE INVENTION

The optical film of the invention includes: a complex type scattering-dichroic absorbing polarizer; a transparent support; and an optically anisotropic layer comprising a discotic or nematic liquid crystal whose molecule has an optical axis tilted with respect to a surface of the transparent support are laminated.

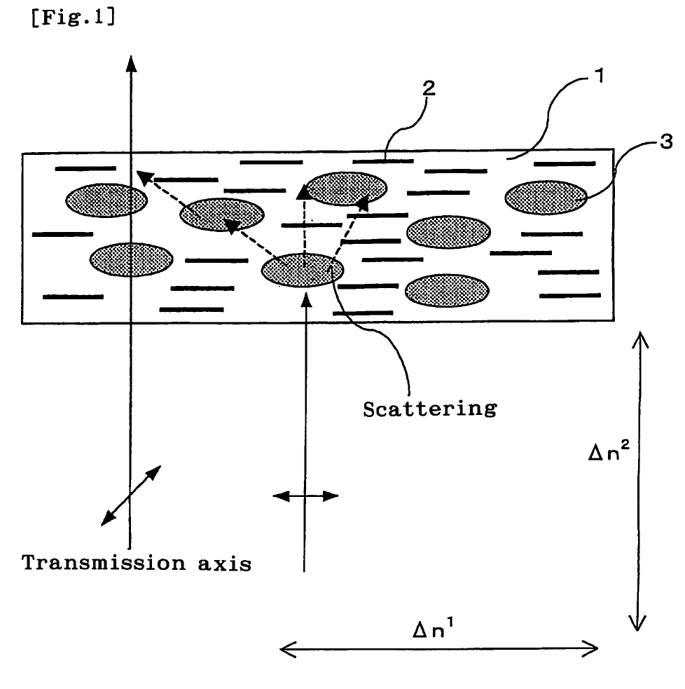

A complex type scattering-dichroic absorbing polarizer of this invention will, hereinafter, be described referring to drawings. FIG. 1 is a conceptual view of a complex type absorbing polarizer of this invention, and the polarizer has a structure where a film is formed with an optically-transparent water-soluble resin 1 including an iodine based light absorbing material 2, and minute domains 3 are dispersed in the film concerned as a matrix. As described above, the complex type absorbing polarizer according to the invention includes the iodine based light-absorbing material 2 preferentially in the optically-transparent thermoplastic resin 1, which forms the film serving as a matrix. However, the iodine based light-absorbing material 2 may also be allowed to exist in the minute domains 3 as long as it will have no optical effect.

FIG. 1 shows an example of a case where the iodine based light absorbing material 2 is oriented in a direction of axis (Δn¹ direction) in which a refractive index difference between the minute domain 3 and the optically-transparent water-soluble resin 1 shows a maximal value. In minute domain 3, a polarized component in the Δn¹ direction is scattered. In FIG. 1, the Δn¹ direction in one direction in a film plane is an absorption axis. In the film plane, a Δn² direction perpendicular to the Δn¹ direction serves as a transmission axis. Another Δn² direction perpendicular to the Δn¹ direction is a thickness direction.

As optically-transparent water-soluble resins 1, resins having optically-transparency in a visible light band and dispersing and absorbing the iodine based light absorbing materials may be used without particular limitation. For example, polyvinyl alcohols or derivatives thereof conventionally used for polarizers may be mentioned. As derivatives of polyvinyl alcohol, polyvinyl formals, polyvinyl acetals, etc. may be mentioned, and in addition derivatives modified with olefins, such as ethylene and propylene, and unsaturated carboxylic acids, such as acrylic acid, methacrylic acid, and crotonic acid, alkyl esters of unsaturated carboxylic acids, acrylamides etc. may be mentioned. Besides, as optically-transparent water-soluble resin 1, for example, polyvinyl pyrrolidone based resins, amylose based resins, etc. may be mentioned. The above-mentioned optically-transparent water-soluble resin may be of resins having isotropy not easily generating orientation birefringence caused by molding deformation etc., and of resins having anisotropy easily generating orientation birefringence.

Examples of the optically-transparent resin 1 also include polyester resins such as polyethylene terephthalate and polyethylene naphthalate; styrene resins such as polystyrene and acrylonitrile-styrene copolymers (AS resins); and olefin resins such as polyethylene, polypropylene, cyclo type- or norbornene structure-containing polyolefins, and olefin based resins such as ethylene-propylene copolymers. Examples thereof also include vinyl chloride resins, cellulose resins, acrylic resins, amide resins, imide resins, sulfone polymers, polyethersulfone resins, polyetheretherketone resin polymers, polyphenylene sulfide resins, vinylidene chloride resins, vinyl butyral resins, arylate resins, polyoxymethylene resins, silicone resins, and urethane resins. One or more of these resins may be used either individually or in any combination. Any cured material of a thermosetting or ultraviolet-curable type resins such as a phenol based, melamine based, acrylic based, urethane, acrylic-urethane based, epoxy based, or silicone based resin may also be used.

In materials forming minute domains 3, it is not limited whether the material has birefringence or isotropy, but materials having birefringence is particularly preferable. Moreover, as materials having birefringence, materials (henceforth, referred to as liquid crystalline material) showing liquid crystallinity at least at the time of orientation treatment may preferably used. That is, the liquid crystalline material may show or may lose liquid crystallinity in the formed minute domain 3, as long as it shows liquid crystallinity at the orientation treatment time.

As materials forming minute domains 3, materials having birefringences (liquid crystalline materials) may be any of materials showing nematic liquid crystallinity, smectic liquid crystallinity, and cholesteric liquid crystallinity, or of materials showing lyotropic liquid crystallinity. Moreover, materials having birefringence may be of liquid crystalline thermoplastic resins, and may be formed by polymerization of liquid crystalline monomers. When the liquid crystalline material is of liquid crystalline thermoplastic resins, in the view point of heat-resistance of structures finally obtained, resins with high glass transition temperatures may be preferable. Furthermore, it is preferable to use materials showing glass state at least at room temperatures. Usually, a liquid crystalline thermoplastic resin is oriented by heating, subsequently cooled to be fixed, and forms minute domains 3 while liquid crystallinity are maintained. Although liquid crystalline monomers after orienting can form minute domains 3 in the state of fixed by polymerization, cross-linking, etc., some of the formed minute domains 3 may lose liquid crystallinity.

As the above-mentioned liquid crystalline thermoplastic resins, polymers having various skeletons of principal chain types, side chain types, or compounded types thereof may be used without particular limitation. As principal chain type liquid crystal polymers, polymers, such as condensed polymers having structures where mesogen groups including aromatic units etc. are combined, for example, polyester based, polyamide based, polycarbonate based, and polyester imide based polymers, may be mentioned. As the above-mentioned aromatic units used as mesogen groups, phenyl based, biphenyl based, and naphthalene based units may be mentioned, and the aromatic units may have substituents, such as cyano groups, alkyl groups, alkoxy groups, and halogen groups.

As side chain type liquid crystal polymers, polymers having principal chain of, such as polyacrylate based, polymethacrylate based, poly-alpha-halo acrylate based, poly-alpha-halo cyano acrylate based, polyacrylamide based, polysiloxane based, and poly malonate based principal chain as a skeleton, and having mesogen groups including cyclic units etc. in side chains may be mentioned. As the above-mentioned cyclic units used as mesogen groups, biphenyl based, phenyl benzoate based, phenylcyclohexane based, azoxybenzene based, azomethine based, azobenzene based, phenyl pyrimidine based, diphenyl acetylene based, diphenyl benzoate based, bicyclo hexane based, cyclohexylbenzene based, terphenyl based units, etc. may be mentioned. Terminal groups of these cyclic units may have substituents, such as cyano group, alkyl group, alkenyl group, alkoxy group, halogen group, haloalkyl group, haloalkoxy group, and haloalkenyl group. Groups having halogen groups may be used for phenyl groups of mesogen groups.

Besides, any mesogen groups of the liquid crystal polymer may be bonded via a spacer part giving flexibility. As spacer parts, polymethylene chain, polyoxymethylene chain, etc. may be mentioned. A number of repetitions of structural units forming the spacer parts is suitably determined by chemical structure of mesogen parts, and the number of repeating units of polymethylene chain is 0 to 20, preferably 2 to 12, and the number of repeating units of polyoxymethylene chain is 0 to 10, and preferably 1 to 3.

The above-mentioned liquid crystalline thermoplastic resins preferably have glass transition temperatures of 50° C. or more, and more preferably 80° C. or more. Furthermore they have approximately 2,000 to 100,000 of weight average molecular weight.

As liquid crystalline monomers, monomers having polymerizable functional groups, such as acryloyl groups and methacryloyl groups, at terminal groups, and further having mesogen groups and spacer parts including the above-mentioned cyclic units etc. may be mentioned. Crossed-linked structures may be introduced using polymerizable functional groups having two or more acryloyl groups, methacryloyl groups, etc., and durability may also be improved.

Materials forming minute domains 3 are not entirely limited to the above-mentioned liquid crystalline materials, and non-liquid crystalline resins may be used if they are different materials from the matrix materials. As the above-mentioned resins, polyvinyl alcohols and derivatives thereof, polyolefins, polyallylates, polymethacrylates, polyacrylamides, polyethylene terephthalates, acrylic styrene copolymes, etc. may be mentioned. Moreover, particles without birefringence may be used as materials for forming the minute domains 3. As fine-particles concerned, resins, such as polyacrylates and acrylic styrene copolymers, may be mentioned. A size of the fine-particles is not especially limited, and particle diameters of 0.05 to 500 μm may be used, and preferably 0.5 to 100 μm. Although it is preferable that materials for forming minute domains 3 is of the above-mentioned liquid crystalline materials, non-liquid crystalline materials may be mixed and used to the above-mentioned liquid crystalline materials. Furthermore, as materials for forming minute domains 3, non-liquid crystalline materials may also be independently used.

Iodine based light absorbing material means chemical species comprising iodine and absorbs visible light, and it is thought that, in general, they are formed by interaction between optically-transparent water-soluble resins (particularly polyvinyl alcohol based resins) and poly iodine ions (I₃_{^{−}}, I₅_{^{−}}, etc.). An iodine based light absorbing material is also called an iodine complex. It is thought that poly iodine ions are generated from iodine and iodide ions.

Iodine based light absorbing materials having an absorption band at least in a wavelength range of 400 to 700 nm is preferably used.

Examples of the absorbing dichroic material for use as an alternative to the iodine based light absorbing material include absorbing dichroic dyes, absorbing dichroic pigments and the like. In the invention, iodine based light-absorbing materials are preferably used as the absorbing dichroic material. In the case where the optically-transparent resin 1 used as the matrix material is a water-soluble resin such as polyvinyl alcohol, iodine based light-absorbing materials are particularly preferred in terms of high degree of polarization and high transmittance.

Preferably used are absorbing dichroic dyes that have heat resistance and do not lose their dichroism by decomposition or degradation even when the birefringent liquid-crystalline material is aligned by heating. As described above, the absorbing dichroic dye preferably has at least one absorption band with a dichroic ratio of at least 3 in the visible wavelength range. In the evaluation of the dichroic ratio, for example, an appropriate liquid crystal material containing a dissolved dye is used to form a homogeneously aligned liquid crystal cell, and the cell is measured for a polarized absorption spectrum, in which the absorption dichroic ratio at the absorption maximum wavelength is used as an index for evaluating the dichroic ratio. In this evaluation method, E-7 manufactured by Merck & Co. may be used as a standard liquid crystal. In this case, the dye to be used should generally have a dichroic ratio of at least about 3, preferably of at least about 6, more preferably of at least about 9, at the absorption wavelength.

Examples of the dye having such a high dichroic ratio include azo dyes, perylene dyes and anthraquinone dyes, which are preferably used for dye polarizers. Any of these dyes may be used in the form of a mixed dye. For example, these dyes are described in detail in JP-A No. 54-76171.

In the case where a color polarizer is produced, a dye having an absorption wavelength appropriate to the properties of the polarizer may be used. In the case where a neutral gray polarizer is produced, two or more types of dyes may be appropriately mixed such that absorption can occur over the whole visible light range.

In a complex type scattering-dichroic absorbing polarizer of this invention, while producing a film in which a matrix is formed with an optically-transparent water-soluble resin 1 including an iodine based light absorbing material 2, minute domains 3 (for example, an oriented birefringent material formed with liquid crystalline materials) are dispersed in the matrix concerned. Moreover, the above-mentioned refractive index difference (Δn¹) in a Δn¹ direction and a refractive index difference (Δn²) in a Δn² direction are controlled to be in the above-mentioned range in the film.

Manufacturing process of a complex type absorbing polarizer of this invention is not especially limited, and for example, the polarizer of this invention may be obtained using following production processes:
(1) a process for manufacturing a mixed solution in which a material for forming minute domains is dispersed in an optically-transparent water-soluble resin forming a matrix (description is, hereinafter, to be provided, with reference to an example of representation, for a case where a liquid crystalline material is used as a material forming the minute domains. A case by a liquid crystalline material will apply to a case by other materials.);
(2) a process in which a film is formed with the mixed solution of the above-mentioned (1);
(3) a process in which the film obtained in the above-mentioned (2) is oriented (stretched); and
(4) a process in which an iodine based light absorbing material is dispersed (dyed) in the optically-transparent water-soluble resin forming the above-mentioned matrix.
   In addition, an order of the processes (1) to (4) may suitably be determined.

In the above-mentioned process (1), a mixed solution is firstly prepared in which a liquid crystalline material forming minute domains is dispersed in an optically-transparent water-soluble resin forming a matrix. A method for preparing the mixed solution concerned is not especially limited, and a method may be mentioned of utilizing a phase separation phenomenon between the above-mentioned matrix component (an optically-transparent water-soluble resin) and a liquid crystalline material. For example, a method may be mentioned in which a material having poor compatibility between the matrix component as a liquid crystalline material is selected, a solution of the material forming the liquid crystalline material is dispersed using dispersing agents, such as a surface active agent, in a water solution of the matrix component. In preparation of the above-mentioned mixed solution, some of combinations of the optically-transparent material forming the matrix, and the liquid crystal material forming minute domains do not require a dispersing agent. An amount used of the liquid crystalline material dispersed in the matrix is not especially limited, and a liquid crystalline material is 0.01 to 100 parts by weight to an optically-transparent water-soluble resin 100 parts by weight, and preferably it is 0.1 to 10 parts by weight. The liquid crystalline material is used in a state dissolved or not dissolved in a solvent. Examples of solvents, for example, include: water, toluene, xylene, hexane cyclohexane, dichloromethane, trichloromethane, dichloroethane, trichloroethane, tetrachloroethane, trichloroethylene, methyl ethyl ketone, methylisobutylketone, cyclohexanone, cyclopentanone, tetrahydrofuran, ethyl acetate, etc. Solvents for the matrix components and solvents for the liquid crystalline materials may be of same, or may be of different solvents.

In the above-mentioned process (2), in order to reduce foaming in a drying process after a film formation, it is desirable that solvents for dissolving the liquid crystalline material forming minute domains is not used in preparation of the mixed solution in the process (1). When solvents are not used, for example, a method may be mentioned in which a liquid crystalline material is directly added to an aqueous solution of an optically-transparency material forming a matrix, and then is heated above a liquid crystal temperature range in order to disperse the liquid crystalline material uniformly in a smaller state.

In addition, a solution of a matrix component, a solution of a liquid crystalline material, or a mixed solution may include various kinds of additives, such as dispersing agents, surface active agents, ultraviolet absorption agents, flame retardants, antioxidants, plasticizers, mold lubricants, other lubricants, and colorants in a range not disturbing an object of this invention.

In the process (2) for obtaining a film of the above-mentioned mixed solution, the above-mentioned mixed solution is heated and dried to remove solvents, and thus a film with minute domains dispersed in the matrix is produced. As methods for formation of the film, various kinds of methods, such as casting methods, extrusion methods, injection molding methods, roll molding methods, and flow casting molding methods, may be adopted. In film molding, a size of minute domains in the film is controlled to be in a range of 0.05 to 500 μm in a Δn² direction. Sizes and dispersibility of the minute domains may be controlled, by adjusting a viscosity of the mixed solution, selection and combination of the solvent of the mixed solution, dispersant, and thermal processes (cooling rate) of the mixed solvent and a rate of drying. For example, a mixed solution of an optically-transparent water-soluble resin that has a high viscosity and generates high shearing force and that forms a matrix, and a liquid crystalline material forming minute domains is dispersed by agitators, such as a homogeneous mixer, being heated at a temperature in no less than a range of a liquid crystal temperature, and thereby minute domains may be dispersed in a smaller state.

The process (3) giving orientation to the above-mentioned film may be performed by stretching the film. In stretching, uniaxial stretching, biaxial stretching, diagonal stretching are exemplified, but uniaxial stretching is usually performed. Any of dries type stretching in air and wet type stretching in an aqueous system bath may be adopted as the stretching method. When adopting a wet type stretching, an aqueous system bath may include suitable additives (boron compounds, such as boric acid; iodide of alkali metal, etc.) A stretching ratio is not especially limited, and in usual a ratio of approximately 2 to 10 times is preferably adopted.

This stretching may orient the iodine based light absorbing material in a direction of stretching axis. Moreover, the liquid crystalline material forming a birefringent material is oriented in the stretching direction in minute domains by the above-mentioned stretching, and as a result birefringence is demonstrated.

It is desirable the minute domains may be deformed according to stretching. When minute domains are of non-liquid crystalline materials, approximate temperatures of glass transition temperatures of the resins are desirably selected as stretching temperatures, and when the minute domains are of liquid crystalline materials, temperatures making the liquid crystalline materials exist in a liquid crystal state such as nematic phase or smectic phase or an isotropic phase state, are desirably selected as stretching temperatures. When inadequate orientation is given by stretching process, processes, such as heating orientation treatment, may separately be added.

In addition to the above-mentioned stretching, function of external fields, such as electric field and magnetic field, may be used for orientation of the liquid crystalline material. Moreover, liquid crystalline materials mixed with light reactive substances, such as azobenzene, and liquid crystalline materials having light reactive groups, such as a cinnamoyl group, introduced thereto are used, and thereby these materials may be oriented by orientation processing with light irradiation etc. Furthermore, a stretching processing and the above-mentioned orientation processing may also be used in combination. When the liquid crystalline material is of liquid crystalline thermoplastic resins, it is oriented at the time of stretching, cooled at room temperatures, and thereby orientation is fixed and stabilized. Since target optical property will be demonstrated if orientation is carried out, the liquid crystalline monomer may not necessarily be in a cured state. However, in liquid crystalline monomers having low isotropic transition temperatures, a few temperature rise provides an isotropic state. In such a case, since anisotropic scattering may not be demonstrated but conversely polarized light performance deteriorates, the liquid crystalline monomers are preferably cured. Besides, many of liquid crystalline monomers will be crystallized when left at room temperatures, and then they will demonstrate anisotropic scattering and polarized light performance conversely deteriorate, the liquid crystalline monomers are preferably cured. In the view point of these phenomena, in order to make orientation state stably exist under any kind of conditions, liquid crystalline monomers are preferably cured. In curing of a liquid crystalline monomer, for example, after the liquid crystalline monomer is mixed with photopolymerization initiators, dispersed in a solution of a matrix component and oriented, in either of timing (before dyed or after dyed by iodine based light absorbing materials), the liquid crystalline monomer is cured by exposure with ultraviolet radiation etc. to stabilize orientation. Desirably, the liquid crystalline monomer is cured before dyed with iodine based light absorbing materials.

As a process (4) in which the iodine based light absorbing material is dispersed in the optically-transparent water-soluble resin used for forming the above-mentioned matrix, in general, a method in which the above-mentioned film is immersed into a bath of aqueous system including iodine dissolved with auxiliary agents of iodide of alkali metals, such as potassium iodide may be mentioned. As mentioned above, an iodine based light absorbing material is formed by interaction between iodine dispersed in the matrix and the matrix resin. Timing of immersing may be before or after the above-mentioned stretching process (3). The iodine based light absorbing material is, in general, remarkably formed by being passed through a stretching process. A concentration of the aqueous system bath including iodine, and a percentage of the auxiliary agents, such as iodide of alkali metals may not especially be limited, but general iodine dyeing techniques may be adopted, and the above-mentioned concentration etc. may arbitrarily be changed.

Moreover, a percentage of the iodine in the polarizer obtained is not especially limited, but a percentage of the optically-transparent water-soluble resin and the iodine are preferably controlled so that the iodine is 0.05 to 50 parts by weight grade to the optically-transparent water-soluble resin 100 parts by weight, and more preferably 0.1 to 10 parts by weight.

In a case the absorbing dichroic dye is used as the absorbing dichroic material, a percentage of the absorbing dichroic dye in the polarizer obtained is not especially limited, but a percentage of the optically-transparent thermoplastic resin and the absorbing dichroic dye is preferably so that the absorbing dichroic dye is controlled to be 0.01 to 100 parts by weight grade to the optically-transparent thermoplastic resin 100 parts by weight, and more preferably 0.05 to 50 parts by weight.

In production of the complex type absorbing polarizer, processes for various purposes (5) may be given other than the above-mentioned processes (1) to (4). As a process (5), for example, a process in which a film is immersed in water bath and swollen may be mentioned for the purpose of mainly improving iodine dyeing efficiency of the film. Besides, a process in which a film is immersed in a water bath including arbitrary additives dissolved therein may be mentioned. A process in which a film is immersed in an aqueous solution including additives, such as boric acid and borax, for the purpose of cross-linking a water-soluble resin (matrix) may be mentioned. Moreover, for the purpose of mainly adjusting an amount balance of the dispersed iodine based light absorbing materials, and adjusting a hue, a process in which a film is immersed to an aqueous solution including additives, such as an iodide of an alkaline metals may be mentioned.

As for the process (3) of orienting (stretching) of the above-mentioned film, the process (4) of dispersing and dyeing the iodine based light absorbing material to a matrix resin and the above-mentioned process (5), so long as each of the processes (3) and (4) is provided at least 1 time, respectively, a number, order and conditions (a bath temperature, immersion period of time, etc.) of the processes, may arbitrarily be selected, each process may separately be performed and furthermore a plurality of processes may simultaneously be performed. For example, a cross-linking process of the process (5) and the stretching process (3) may be carried out simultaneously.

In addition, although the iodine based light absorbing material used for dyeing, boric acid used for cross-linking are permeated into a film by immersing the film in an aqueous solution as mentioned above, instead of this method, a method may be adopted that arbitrary types and amounts may be added before film formation of the process (2) and before or after preparation of a mixed solution in the process (1). And both methods may be used in combination. However, when high temperatures (for example, no less than 80° C.) is required in the process (3) at the time of stretching etc., in the view point of heat resistance of the iodine based light absorbing material, the process (4) for dispersing and dyeing the iodine based light absorbing material may be desirably performed after the process (3).

A film given the above treatments is desirably dried using suitable conditions. Drying is performed according to conventional methods.

A thickness of the obtained polarizer (film) is not especially limited, in general, but it is 1 μm to 3 mm, preferably 5 μm to 1 mm, and more preferably 10 to 500 μm.

A polarizer obtained in this way does not especially have a relationship in size between a refractive index of the birefringent material forming minute domains and a refractive index of the matrix resin in a stretching direction, whose stretching direction is in a Δn¹ direction and two directions perpendicular to a stretching axis are Δn² directions. Moreover, the stretching direction of an iodine based light absorbing material is in a direction demonstrating maximal absorption, and thus a polarizer having a maximally demonstrated effect of absorption and scattering may be realized.

The above-described polarizer may be used as a polarizing plate with a transparent protective layer prepared at least on one side thereof using a usual method. The transparent protective layer may be prepared as an application layer by polymers, or a laminated layer of films. Proper transparent materials may be used as a transparent polymer or a film material that forms the transparent protective layer, and the material having outstanding transparency, mechanical strength, heat stability and outstanding moisture interception property, etc. may be preferably used. As materials of the above-mentioned protective layer, for example, polyester type polymers, such as polyethylene terephthalate and polyethylenenaphthalate; cellulose type polymers, such as diacetyl cellulose and triacetyl cellulose; acrylics type polymer, such as poly methylmethacrylate; styrene type polymers, such as polystyrene and acrylonitrile-styrene copolymer (AS resin); polycarbonate type polymer may be mentioned. Besides, as examples of the polymer forming a protective film, polyolefin type polymers, such as polyethylene, polypropylene, polyolefin that has cyclo-type or norbornene structure, ethylene-propylene copolymer; vinyl chloride type polymer; amide type polymers, such as nylon and aromatic polyamide; imide type polymers; sulfone type polymers; polyether sulfone type polymers; polyether-ether ketone type polymers; poly phenylene sulfide type polymers; vinyl alcohol type polymer; vinylidene chloride type polymers; vinyl butyral type polymers; arylate type polymers; polyoxymethylene type polymers; epoxy type polymers; or blend polymers of the above-mentioned polymers may be mentioned. Films made of heat curing type or ultraviolet ray curing type resins, such as acryl based, urethane based, acryl urethane based, epoxy based, and silicone based, etc. may be mentioned.

Moreover, as is described in Japanese Patent Laid-Open Publication No. 2001-343529 (WO 01/37007), polymer films, for example, resin compositions including (A) thermoplastic resins having substituted and/or non-substituted imido group is in side chain, and (B) thermoplastic resins having substituted and/or non-substituted phenyl and nitrile group in sidechain may be mentioned. As an illustrative example, a film may be mentioned that is made of a resin composition including alternating copolymer comprising iso-butylene and N-methyl maleimide, and acrylonitrile-styrene copolymer. A film comprising mixture extruded article of resin compositions etc. may be used.

As a transparent protection film, if polarization property and durability are taken into consideration, cellulose based polymer, such as triacetyl cellulose, is preferable, and especially triacetyl cellulose film is suitable. In general, a thickness of a transparent protection film is 500 μm or less, preferably 1 to 300 μm, and especially preferably 5 to 300 μm. In addition, when transparent protection films are provided on both sides of the polarizer, transparent protection films comprising same polymer material may be used on both of a front side and a back side, and transparent protection films comprising different polymer materials etc. may be used.

Moreover, it is preferable that the protection film may have as little coloring as possible. Accordingly, a protection film having a retardation value in a film thickness direction represented by Rth=[(nx+ny)/2−nz]×d of −90 nm to +75 nm (where, nx and ny represent principal indices of refraction in a film plane, nz represents refractive index in a film thickness direction, and d represents a film thickness) may be preferably used. Thus, coloring (optical coloring) of polarizing plate resulting from a protection film may mostly be cancelled using a protection film having a retardation value (Rth) of −90 nm to +75 nm in a thickness direction. The retardation value (Rth) in a thickness direction is preferably −80 nm to +60 nm, and especially preferably −70 nm to +45 nm.

A hard coat layer may be prepared, or antireflection processing, processing aiming at sticking prevention, diffusion or anti glare may be performed onto the face on which the polarizer of the above described transparent protective film has not been adhered.

A hard coat processing is applied for the purpose of protecting the surface of the polarizing plate from damage, and this hard coat film may be formed by a method in which, for example, a curable coated film with excellent hardness, slide property etc. is added on the surface of the protective film using suitable ultraviolet curable type resins, such as acrylic type and silicone type resins. Antireflection processing is applied for the purpose of antireflection of outdoor daylight on the surface of a polarizing plate and it may be prepared by forming an antireflection film according to the conventional method etc. Besides, a sticking prevention processing is applied for the purpose of adherence prevention with adjoining layer.

In addition, an anti glare processing is applied in order to prevent a disadvantage that outdoor daylight reflects on the surface of a polarizing plate to disturb visual recognition of transmitting light through the polarizing plate, and the processing may be applied, for example, by giving a fine concavo-convex structure to a surface of the protective film using, for example, a suitable method, such as rough surfacing treatment method by sandblasting or embossing and a method of combining transparent fine particle. As a fine particle combined in order to form a fine concavo-convex structure on the above-mentioned surface, transparent fine particles whose average particle size is 0.5 to 50 μm, for example, such as inorganic type fine particles that may have conductivity comprising silica, alumina, titania, zirconia, tin oxides, indium oxides, cadmium oxides, antimony oxides, etc., and organic type fine particles comprising cross-linked of non-cross-linked polymers may be used. When forming fine concavo-convex structure on the surface, the amount of fine particle used is usually about 2 to 50 weight parts to the transparent resin 100 weight parts that forms the fine concavo-convex structure on the surface, and preferably 5 to 25 weight parts. An anti glare layer may serve as a diffusion layer (viewing angle expanding function etc.) for diffusing transmitting light through the polarizing plate and expanding a viewing angle etc.

In addition, the above-mentioned antireflection layer, sticking prevention layer, diffusion layer, anti glare layer, etc. may be built in the protective film itself, and also they may be prepared as an optical layer different from the protective layer.

Adhesives are used for adhesion processing of the above described polarizer and the transparent protective film. As adhesives, isocyanate derived adhesives, polyvinyl alcohol derived adhesives, gelatin derived adhesives, vinyl polymers derived latex type, aqueous polyesters derived adhesives, etc. may be mentioned. The above-described adhesives are usually used as adhesives comprising aqueous solution, and usually contain solid of 0.5 to 60% by weight.

A polarizing plate of the present invention is manufactured by adhering the above described transparent protective film and the polarizer using the above described adhesives. The application of adhesives may be performed to any of the transparent protective film or the polarizer, and may be performed to both of them. After adhered, drying process is given and the adhesion layer comprising applied dry layer is formed. Adhering process of the polarizer and the transparent protective film may be performed using a roll laminator etc. Although a thickness of the adhesion layer is not especially limited, it is usually approximately 0.1 to 5 μm.

The elliptically polarizing plate of the invention is a combination of a complex type absorbing polarizer (which may be laminated with the protective film or the like to form a complex type absorbing polarizing plate), a transparent support and an optically anisotropic layer comprising a discotic or nematic liquid crystal whose molecule has an optical axis tilted with respect to a surface of the transparent support.

Any material that is optically transparent, such as the materials illustrated with respect to the protective film, may be used for the transparent support. The transparent support may also serve as the protective film for the polarizing plate.

For example, the method for forming a tilted alignment layer of a discotic or nematic liquid crystal on the transparent support may include the steps of: allowing a polymerizable liquid crystal or a polymer liquid crystal to have a tilted alignment state under the application of an electric field, a magnetic field or the like or through the process of applying an alignment film to the support and rubbing it or irradiating it with ultraviolet light; and then fixing the liquid crystal by means of light or heat in the former case or by rapid cooling in the latter case. Alternatively, a discotic or nematic liquid crystal is allowed to have a tilted alignment state on other alignment substrate and then transferred onto the transparent support by the use of an optically-transparent adhesive or pressure-sensitive adhesive.

The optically isotropic layer comprising a discotic or nematic liquid crystal whose molecule has an optical axis tilted with respect to the surface of the transparent support preferably has a fixed alignment state in which the tilt of the optical axis varies in the film thickness direction. The optically isotropic layer with such tilted alignment has neither a symmetric form about the 0° incidence center nor a point where the retardation is zero, when a sample of the layer is measured for retardation while plus or minus direction inclined from the normal direction of the layer toward the tilt direction of the optical axis. For example, Wide View Film manufactured by Fuji Photo Film Co., Ltd. may be used in which the tilted alignment layer of a discotic liquid crystal is formed on a cellulose polymer film, or NH Film manufactured by NIPPON OIL CORPORATION may be used in which the tilted alignment layer uses a nematic liquid crystal. Two or more layers of the transparent support and two or more optically anisotropic layers may also be laminated so that optical properties such as retardation can be controlled.

While the complex type absorbing polarizer (or the complex type absorbing polarizing plate), the transparent support and the optically anisotropic layer comprising a discotic or nematic liquid crystal whose molecule has an optical axis tilted with respect to a surface of the transparent support. may be only stacked to form the elliptically polarizing plate of the invention, they are preferably laminated with no air space left between them by the use of an adhesive or pressure-sensitive adhesive, in terms of workability or light use efficiency.

The adhesive and the pressure-sensitive adhesive are not especially limited. For example, acrylic type polymers; silicone type polymers; polyesters, polyurethanes, polyamides, polyethers; fluorine type and rubber type polymers, such as natural rubber, synthetic rubber may be suitably selected as a base polymer. Especially, the adhesive and the pressure-sensitive may be preferably used, which is excellent in optical transparency, showing adhesion characteristics with moderate wettability, cohesiveness and adhesive property and has outstanding weather resistance, heat resistance, etc.

The adhesive or the pressure-sensitive adhesive preferably has no absorption in the visible light range and preferably has a refractive index as close as possible to the refractive index of each layer in terms of suppressing surface reflection. In this point of view, for example, acrylic pressure-sensitive adhesives are preferably used.

The adhesive or the pressure-sensitive adhesive may contain any crosslinking agent appropriate to the base polymer. The adhesive layer may contain additives, for example, such as natural or synthetic resins, adhesive resins, glass fibers, glass beads, metal powder, fillers comprising other inorganic powder etc., pigments, colorants and antioxidants. Moreover, it may be an adhesive layer that contains fine particle and shows optical diffusion nature.

In addition, in the present invention, ultraviolet absorbing property may be given to the above-mentioned each layer, such as an optical film etc. and a pressure-sensitive adhesive layer, using a method of adding UV absorbents, such as salicylic acid ester type compounds, benzophenol type compounds, benzotriazol type compounds, cyano acrylate type compounds, and nickel complex salt type compounds.

The adhesive or the pressure-sensitive adhesive is generally used in the form of an adhesive solution with a solids content of about 10 to about 50% by weight, in which the base polymer or a composition thereof is dissolved or dispersed in a solvent. Any appropriate solvent such as water and an organic solvent such as toluene and ethyl acetate may be selected and used depending on the type of the adhesive.

The adhesive layer and the pressure-sensitive adhesive layer may also be prepared on one side or both sides of the polarizing plate or the optical film as a layer in which pressure-sensitive adhesives with different composition or different kind etc. are laminated together. Thickness of the pressure-sensitive adhesive layer may be suitably determined depending on a purpose of usage or adhesive strength, etc., and generally is 1 to 500 μm, preferably 5 to 200 μm, and more preferably 10 to 100 μm.

When the optical films are bonded, their optical axes may be set at appropriate angles depending on the desired retardation properties. According the invention, the complex type absorbing polarizer (or the complex type absorbing polarizing plate), the transparent support, and the optically isotropic layer may be used in the form of rolls or sheets in a method of bonding and laminating them, while it is preferred that appropriate methods of using them should be selected depending purposes. The bonding is preferably performed under such conditions that the angle between the direction of the alignment angle of the optically anisotropic layer measured with a birefringence meter and the direction of stretching of the polarizer is 0±10°, preferably 0±8°. The bonding performed under such conditions is preferred because both good front contrast and good viewing angle property can be achieved in the display characteristics.

An adhesive layer and a pressure-sensitive adhesive layer may be prepared on the elliptically polarizing plate. The pressure-sensitive adhesive layer is used for adhesion with a liquid crystal cell, and lamination other optical layers.

A temporary separator is attached to an exposed side of an pressure-sensitive adhesive layer to prevent contamination etc., until it is practically used. Thereby, it can be prevented that foreign matter contacts pressure-sensitive adhesive layer in usual handling. As a separator, without taking the above-mentioned thickness conditions into consideration, for example, suitable conventional sheet materials that is coated, if necessary, with release agents, such as silicone type, long chain alkyl type, fluorine type release agents, and molybdenum sulfide may be used. As a suitable sheet material, plastics films, rubber sheets, papers, cloths, no woven fabrics, nets, foamed sheets and metallic foils or laminated sheets thereof may be used.

The elliptically polarizing plate of the invention may be used for a liquid crystal display in a conventional manner. The liquid crystal display may include a liquid crystal cell, polarizing plates placed on both sides of the liquid crystal cell, and any of various types of optical layers and the like. The above-mentioned elliptically polarizing plate or the optical film is used on at least one side of the liquid crystal cell. The liquid crystal display may be formed in a conventional manner. Specifically, a general liquid crystal display may be formed by assembling a liquid crystal cell, optical elements, and optional components such as a lighting system in an appropriate manner and incorporating a driving circuit and the like, while any conventional techniques may be used except that the optical film of the invention is used. The liquid crystal cell may be of any type such as TN type, STN type and π type.

Additionally, any other appropriate components such as a diffusing plate, an antiglare layer, an antireflection film, a protective plate, a prism array, a lens array sheet, a light diffusion plate, and a backlight may also be placed in one or more layers at appropriate positions to form a liquid crystal display.

While the above-mentioned elliptically polarizing plate or the optical film may be formed by independently and sequentially laminating the components in the process of manufacturing a liquid crystal display or the like, the elliptically polarizing plate or the optical film formed by pre-lamination has the advantages that it has stable quality and good assembling workability and can improve the process of manufacturing liquid crystal displays or the like. The lamination may be performed using any appropriate adhesive means such as a pressure-sensitive adhesive layer. In the process of bonding the elliptically polarizing plate or any other optical film, their optical axes may be arranged so as to make an appropriate angles depending on the desired retardation properties.

An elliptically polarizing plate of the present invention may be used in practical use as an optical layer laminated with other optical layers. Although there is especially no limitation about the optical layers, one layer or two layers or more of optical layers, which may be used for formation of a liquid crystal display etc., such as a reflector, a transflective plate, a retardation plate (a half wavelength plate and a quarter wavelength plate included), and a viewing angle compensation film, may be used. Especially preferable elliptically polarizing plates are; a reflection type polarizing plate or a transflective type polarizing plate in which a reflector or a transflective reflector is further laminated onto the polarizing plate; a polarizing plate in which a retardation plate is further laminated; or a polarizing plate in which a brightness enhancement film is further laminated onto the polarizing plate.

A reflective layer is prepared on a polarizing plate to give a reflection type polarizing plate, and this type of plate is used for a liquid crystal display in which an incident light from a view side (display side) is reflected to give a display. This type of plate does not require built-in light sources, such as a backlight, but has an advantage that a liquid crystal display may easily be made thinner. A reflection type polarizing plate may be formed using suitable methods, such as a method in which a reflective layer of metal etc. is, if required, attached to one side of a polarizing plate through a transparent protective layer etc.

In addition, a transflective type polarizing plate may be obtained by preparing the above-mentioned reflective layer as a transflective type reflective layer, such as a half-mirror etc. that reflects and transmits light. A transfiective type polarizing plate is usually prepared in the backside of a liquid crystal cell and it may form a liquid crystal display unit of a type in which a picture is displayed by an incident light reflected from a view side (display side) when used in a comparatively well-lighted atmosphere. And this unit displays a picture, in a comparatively dark atmosphere, using embedded type light sources, such as a back light built in backside of a transfiective type polarizing plate. That is, the transflective type polarizing plate is useful to obtain of a liquid crystal display of the type that saves energy of light sources, such as a back light, in a well-lighted atmosphere, and can be used with a built-in light source if needed in a comparatively dark atmosphere etc.

The above-mentioned elliptically polarizing plate may be used on which the retardation plate is further laminated. A description of the above-mentioned will be made in the following paragraph. These polarizing plates change linearly polarized light into elliptically polarized light or circularly polarized light, elliptically polarized light or circularly polarized light into linearly polarized light or change the polarization direction of linearly polarization by a function of the retardation plate. As a retardation plate that changes circularly polarized light into linearly polarized light or linearly polarized light into circularly polarized light, what is called a quarter wavelength plate (also called λ/4 plate) is used. Usually, half-wavelength plate (also called λ/2 plate) is used, when changing the polarization direction of linearly polarized light.

Elliptically polarizing plate is effectively used to give a monochrome display without above-mentioned coloring by compensating (preventing) coloring (blue or yellow color) produced by birefringence of a liquid crystal layer of a super twisted nematic (STN) type liquid crystal display. Furthermore, a polarizing plate in which three-dimensional refractive index is controlled may also preferably compensate (prevent) coloring produced when a screen of a liquid crystal display is viewed from an oblique direction. Circularly polarizing plate is effectively used, for example, when adjusting a color tone of a picture of a reflection type liquid crystal display that provides a colored picture, and it also has function of antireflection. For example, a retardation plate may be used that compensates coloring and viewing angle, etc. caused by birefringence of various wavelength plates or liquid crystal layers etc. Besides, optical characteristics, such as retardation, may be controlled using laminated layer with two or more sorts of retardation plates having suitable retardation value according to each purpose. As retardation plates, birefringence films formed by stretching films comprising suitable polymers, such as polycarbonates, norbornene type resins, polyvinyl alcohols, polystyrenes, poly methyl methacrylates, polypropylene; polyallylates and polyamides; oriented films comprising liquid crystal materials, such as liquid crystal polymer; and films on which an alignment layer of a liquid crystal material is supported may be mentioned. A retardation plate may be a retardation plate that has a proper retardation according to the purposes of use, such as various kinds of wavelength plates and plates aiming at compensation of coloring by birefringence of a liquid crystal layer and of visual angle, etc., and may be a retardation plate in which two or more sorts of retardation plates is laminated so that optical properties, such as retardation, may be controlled.

As tilt alignment film, for example, a film obtained using a method in which a heat shrinking film is adhered to a polymer film, and then the combined film is heated and stretched or shrunk under a condition of being influenced by a shrinking force, or a film that is oriented in oblique direction may be mentioned.

The polarizing plate with which a polarizing plate and a brightness enhancement film are adhered together is usually used being prepared in a backside of a liquid crystal cell. A brightness enhancement film shows a characteristic that reflects linearly polarized light with a predetermined polarization axis, or circularly polarized light with a predetermined direction, and that transmits other light, when natural light by back lights of a liquid crystal display or by reflection from a back-side etc., comes in. The polarizing plate, which is obtained by laminating a brightness enhancement film to a polarizing plate, thus does not transmit light without the predetermined polarization state and reflects it, while obtaining transmitted light with the predetermined polarization state by accepting a light from light sources, such as a backlight. This polarizing plate makes the light reflected by the brightness enhancement film further reversed through the reflective layer prepared in the backside and forces the light re-enter into the brightness enhancement film, and increases the quantity of the transmitted light through the brightness enhancement film by transmitting a part or all of the light as light with the predetermined polarization state. The polarizing plate simultaneously supplies polarized light that is difficult to be absorbed in a polarizer, and increases the quantity of the light usable for a liquid crystal picture display etc., and as a result luminosity may be improved.

The suitable films are used as the above-mentioned brightness enhancement film. Namely, multilayer thin film of a dielectric substance; a laminated film that has the characteristics of transmitting a linearly polarized light with a predetermined polarizing axis, and of reflecting other light, such as the multilayer laminated film of the thin film having a different refractive-index anisotropy; an aligned film of cholesteric liquid-crystal polymer; a film that has the characteristics of reflecting a circularly polarized light with either left-handed or right-handed rotation and transmitting other light, such as a film on which the aligned cholesteric liquid crystal layer is supported; etc. may be mentioned.

Subsequently, organic electro luminescence equipment (organic EL display) will be explained. Generally, in organic EL display, a transparent electrode, an organic luminescence layer and a metal electrode are laminated on a transparent substrate in an order configuring an illuminant (organic electro luminescence illuminant). Here, an organic luminescence layer is a laminated material of various organic thin films, and much compositions with various combination are known, for example, a laminated material of hole injection layer comprising triphenylamine derivatives etc., a luminescence layer comprising fluorescent organic solids, such as anthracene; a laminated material of electronic injection layer comprising such a luminescence layer and perylene derivatives, etc.; laminated material of these hole injection layers, luminescence layer, and electronic injection layer etc.

In an organic EL display containing an organic electro luminescence illuminant equipped with a transparent electrode on a surface side of an organic luminescence layer that emits light by impression of voltage, and at the same time equipped with a metal electrode on a back side of organic luminescence layer, a retardation plate may be installed between these transparent electrodes and a polarizing plate, while preparing the polarizing plate on the surface side of the transparent electrode.

Since the retardation plate and the polarizing plate have function polarizing the light that has entered as incident light from outside and has been reflected by the metal electrode, they have an effect of making the mirror surface of metal electrode not visible from outside by the polarization action. If a retardation plate is configured with a quarter wavelength plate and the angle between the two polarization directions of the polarizing plate and the retardation plate is adjusted to π/4, the mirror surface of the metal electrode may be completely covered.

### EXAMPLES

Examples of this invention will, hereinafter, be shown, and specific descriptions will be provided. In addition, “parts” in following sections represents parts by weight.

### Example 1

### <Preparation of Complex Type Scattering-Dichroic Absorbing Polarizing Plate >

### (Complex Type Scattering-Dichroic Absorbing Polarizer)

A polyvinyl alcohol aqueous solution with a solid matter content of 13 weight % in which a polyvinyl alcohol resin with a polymerization degree of 2400 and a saponification degree of 98.5%, a liquid crystalline monomer (a nematic liquid crystal temperature is in the range of from 40 to 70°) having an acryloyl group at each of both terminals of a mesogen group and glycerin were mixed together so that a ratio of polyvinyl alcohol: a liquid crystalline monomer: glycerin=100:5:15 (in weight ratio) and the mixture was heated to a temperature equal to or higher than a liquid crystal temperature range and agitated with a homomixer to thereby obtain a mixed solution. Bubbles existing in the mixed solution were defoamed by leaving the solution at room temperature (23° C.) as it was, thereafter, the solution is coated by means of a casting method, subsequently thereto, and the wet coat was dried and to thereafter obtains a whitened mixed film with a thickness of 70 μm. The mixed film was heat-treated at 130° C. for 10 min.

The mixed film was immersed in a water bath at 30° C. and swollen, thereafter, the swollen film was stretched about three times while being immersed in an aqueous solution of iodine and potassium iodide in a ratio of 1 to 7 in weight (a dyeing bath, with a concentration of 0.32 weight %) at 30° C., thereafter the stretched film was further stretched to a total stretch magnification of being about six times while being immersed in a 3 weight % boric acid aqueous solution (crosslinking bath) at 50° C., followed by immersing further the stretched film in 4 weight % boric acid aqueous solution (crosslinking bath) at 50° C. Then, hue adjustment was conducted by immersing the film in 5 weight % potassium iodide aqueous solution bath at 30° C. Subsequent thereto, the film was dried at 50° C. for 4 minutes to obtain a polarizer of the present invention.

### (Confirmation of Generation of Anisotropic Scattering and Measurement of Refractive Index)

The obtained polarizer was observed under a polarization microscope and it was able to be confirmed that numberless dispersed minute domains of a liquid crystalline monomer were formed in a polyvinyl alcohol matrix. The liquid crystalline monomer is oriented in a stretching direction and an average size of minute domains in the stretching direction (Δn¹ direction) was in the range of from 5 to 10 μm. And an average size of minute domains in a direction perpendicular to the stretching direction (Δn² direction) was in the range of from 0.5 to 3 μm.

Refractive indices of the matrix and the minute domain were separately measured. Measurement was conducted at 20° C. A refractive index of a stretched film constituted only of a polyvinyl alcohol film stretched in the same conditions as the wet stretching was measured with an Abbe's refractometer (measurement light wavelength with 589 nm) to obtain a refractive index in the stretching direction (Δn¹ direction)=1.54 and a refractive index in Δn² direction=1.52. Refractive indexes (nₑ: an extraordinary light refractive index and n₀: an ordinary light refractive index) of a liquid crystalline monomer were measured. An ordinary light refractive index n₀ was measured of the liquid crystalline monomer orientation-coated on a high refractive index glass which is vertical alignment-treated with an Abbe's refractometer (measurement light with 589 nm). On the other hand, the liquid crystalline monomer is injected into a liquid crystal cell which is homogenous alignment-treated and a retardation (Δn×d) was measured with an automatic birefringence measurement instrument (automatic birefringence meter KOBRA21ADH) manufactured by Ohoji Keisokuki K.K.) and a cell gap (d) was measured separately with an optical interference method to calculate Δn from retardation/cell gap and to obtain the sum of Δn and n₀ as nₑ. An extraordinary light refractive index nₑ (corresponding to a refractive index in the Δn¹ direction)=1.64 and n₀ (corresponding to a refractive index of Δn² direction)=1.52. Therefore, calculation was resulted in Δn¹=1.64−1.52=0.10 and Δn²=1.52−1.52=0.00. It was confirmed from the measurement described above that a desired anisotropic scattering was able to occur.

### (Polarizing Plate)

Triacetylcellulose films (each with a thickness of 80 μm) were laminated with a polyurethane adhesive on both sides of the complex type absorbing polarizer to form a complex type absorbing polarizing plate.

### <Optical Compensation Layer (1)>

Wide View (WV) Film manufactured by Fuji Photo Film Co., Ltd. was used, which included a transparent support of a cellulose polymer film and a tilted alignment layer of a discotic liquid crystal molecule provided on the cellulose polymer film.

The tilted alignment layer of the discotic liquid crystal molecule was separated from WV Film, and the properties at a wavelength (λ) of 590 nm were measured with KOBRA-21ADH manufactured by Oji Scientific Instruments. The maximum in-plane refractive index was represented by nx, the refractive index in a direction perpendicular to the direction where the maximum in-plane refractive index was obtained was represented by ny, and the refractive index in the thickness direction was represented by nz. The thickness was represented by d. With respect to the transparent support, Δnd=(nx−ny)d was 12 nm, and Rth=(nx−nz)d was 100 nm. The tilted alignment layer was measured for retardation, while the angle of incidence was changed from −50° to 50° toward the directions of the tilted optical axes, and as a result of the measurement, Δnd was 30 nm, Rth was 150 nm and the average tilt angle θ was 17°.

### <Optical Compensation Layer (2)>

NH Film manufactured by NIPPON OIL CORPORATION was used, which included a transparent support of a cellulose polymer film (a triacetylceliulose film) and a tilted alignment layer of a rod-like nematic liquid crystal molecule provided on the cellulose polymer film.

The tilted alignment layer of the rod-like nematic liquid crystal molecule was separated from NH Film, and the properties were measured with KOBRA-21ADH manufactured by Oji Scientific Instruments in the same way as described above. With respect to the transparent support, Δnd was 4 nm and Rth was 50 nm. The tilted alignment layer was measured for retardation, while the angle of incidence was changed from −50° to 50° toward the directions of the tilted optical axes, and as a result of the measurement, Δnd was 95 nm, Rth was 67 nm and the average tilt angle θ was 60°.

### Example 1

The resulting complex type scattering-dichroic absorbing polarizing plate was adhered through an acrylic pressure-sensitive adhesive to the transparent support side of the optical compensation layer (1) to form an elliptically polarizing plate. The complex type absorbing polarizing plate was adhered to the optical compensation layer such that the angle between the stretching axis of the polarizing plate and the alignment angle direction of the tilted alignment layer of the optical compensation layer became 0°. The alignment angle was measured with an automatic birefringence analyzer KOBRA-21ADH (manufactured by Oji Scientific Instruments).

### Example 2

An elliptically polarizing plate was obtained using the process of Example 1 except that the optical compensation layer (2) was used in place of the optical compensation layer (1).

### Comparative Example 1

A polarizer was prepared in the same manner as described above, except that the liquid-crystalline monomer was not used in the preparation of the complex type scattering-dichroic absorbing polarizer. Using the resulting polarizer, a polarizing plate was prepared in the same manner as describe above. An elliptically polarizing plate was also prepared using the process of Example 1, except that the resulting polarizing plate was alternatively used.

### Comparative Example 2

A polarizer was prepared in the same manner as described above, except that the liquid-crystalline monomer was not used in the preparation of the complex type scattering-dichroic absorbing polarizer. Using the resulting polarizer, a polarizing plate was prepared in the same manner as describe above. An elliptically polarizing plate was also prepared using the process of Example 2, except that the resulting polarizing plate was alternatively used.

### (Evaluation)

Polarizing plates obtained in Example 1 and Comparative example 1 were measured for optical properties using a spectrophotometer with integrating sphere (manufactured by Hitachi Ltd. U-4100). Transmittance to each linearly polarized light was measured under conditions in which a completely polarized light obtained through Glan Thompson prism polarizer was set as 100%. Transmittance was calculated based on CIE 1931 standard colorimetric system, and is shown with Y value, for which relative spectral responsivity correction was carried out. Notation k₁ represents a transmittance of a linearly polarized light in a maximum transmittance direction, and k₂ represents a transmittance of a linearly polarized light perpendicular to the direction.

A polarization degree P was calculated with an equation P={(k₁−k₂)/(k₁+k₂)}×100. A transmittance T of a simple substance was calculated with an equation T=(k₁+k₂)/2.

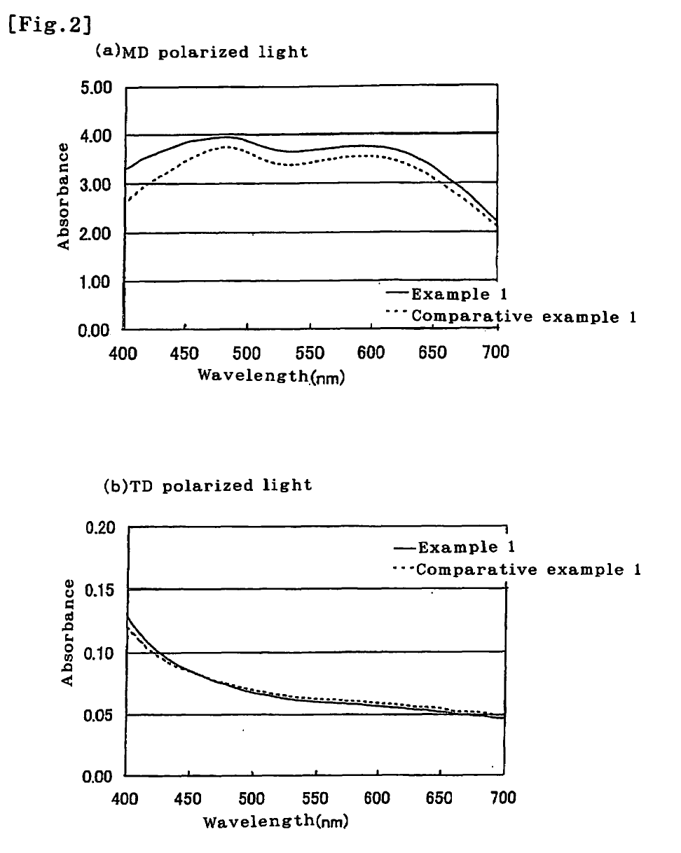

Furthermore, polarizers obtained in Example 1 and Comparative example 1 were measured for a polarized light absorption spectrum using a spectrophotometer (manufactured by Hitachi Ltd. U-4100) with Glan Thompson prism. FIG. 2 shows polarized light absorption spectra of polarizers obtained in Example 1 and Comparative example 1. “MD polarized lights” in FIG. 2(a) represent polarized light absorption spectra when a polarized light with a plane of vibration parallel to a stretching axis enters, and “TD polarized lights” in FIG. 2(b) represent polarized light absorption spectra when a polarized light with a plane of vibration perpendicular to a stretching axis enters.

In TD polarized lights (=transmission axis of polarizer), in visible range whole band, while absorbance of the polarizers in Example 1 and Comparative example 1 showed almost equal value, in MD polarized lights (=absorption of polarizer+scattering axis), absorbance in the polarizer of Example 1 exceeded absorbance of the polarizer in Comparative example 1 in shorter wavelength side. That is, the above-mentioned result shows that light polarizing performance of the polarizer in Example 1 exceeded performance of the polarizer in Comparative example 1 in a short wavelength side. Since all conditions, such as stretching and dyeing, are equivalent in Example 1 and Comparative example 1, it is thought that orientation of iodine based light absorbing materials is also equivalent. Therefore, as mentioned above, a rise of absorbance in MD polarized light of the polarizer of Example 1 shows that light polarizing performance improved by an effect caused by an effect of anisotropic scattering having been added to absorption by iodine.

In haze values, a haze value to a linearly polarized light in a maximum transmittance direction, and a haze value to a linearly polarized light in an absorption direction (a perpendicular direction). Measurement of a haze value was performed according to JIS K7136 (how to obtain a haze of plastics-transparent material), using a haze meter (manufactured by Murakami Color Research Institute HM-150). A commercially available polarizing plate (NPF-SEG1224DU manufactured by NITTO DENKO CORP.: 43% of simple substance transmittances, 99.96% of polarization degree) was arranged on a plane of incident side of a measurement light of a sample, and stretching directions of the commercially available polarizing plate and the sample (polarizer) were made to perpendicularly intersect, and a haze value was measured. However, since quantity of light at the time of rectangular crossing is less than limitations of sensitivity of a detecting element when a light source of the commercially available haze meter is used, light by a halogen lamp which has high optical intensity provided separately was made to enter with a help of an optical fiber device, thereby quantity of light was set as inside of sensitivity of detection, and subsequently a shutter closing and opening motion was manually performed to obtain a haze value to be calculated.

TABLE 1

| | Transmittance of linearly | | | | | |
|---|---|---|---|---|---|---|
| | polarized light (%) | | Single | | haze value (%) | |
| | Maximum | | substance | | Maximum | |
| | transmission | Perpendicular | transmittance | Polarization | transmission | Perpendicular |
| | direction (k₁) | direction (k₂) | (%) | degree (%) | direction | direction |
| Example 1 | 87.00 | 0.035 | 43.53 | 99.92 | 1.8 | 82.0 |
| Comparative | 87.00 | 0.043 | 43.52 | 99.90 | 0.3 | 0.2 |
| Example 1 | | | | | | |

Table 1 shows that the polarizing plate in each of the example and the comparative example has good polarization properties such as a high single substance transmittance and a high degree of polarization. In the example, the polarizing plate uses a polarizer having a structure that includes a matrix formed of an optically-transparent water-soluble resin containing an iodine based light-absorbing material and minute domains dispersed in the matrix. Thus, it is apparent that the haze value with respect to the transmittance in the perpendicular direction is higher in the example than in the comparative example where the polarizing plate uses a conventional polarizer and that the unevenness caused by uneven transmittance is concealed by scattering so that it cannot be detected in the example.

(Evaluation of Viewing Angle of Liquid Crystal Panel with Attachments)

The elliptically polarizing plate of each of Examples 1 and 2 and Comparative Examples 1 and 2 was adhered through a pressure-sensitive adhesive to both sides of a TN-mode liquid crystal panel. The elliptically polarizing plate was placed such that the optical compensation layer side faced the liquid crystal panel. Using EZ Contrast manufactured by ELDIM, the assembly was measured for viewing angle properties with respect to display contrast on the liquid crystal panel. Evaluation was also performed on Comparative Example 3 (in the case where the complex type absorbing polarizer used in Example 1 or 2 was used alone) and Comparative Example 4 (in the case where the polarizer used in Comparative Example 1 or 2 was used alone). The results are shown in Table 2.

Front Contrast: The transmittance in the front direction was measured in terms of Y-value corrected for visibility according to CIE 1931 color system, and the Yw/Yb value calculated from the transmittance (Yw) for white viewing and the transmittance (Yb) for black viewing was defined as the front contrast.

Viewing Angle: The contrast was measured in each of upward, downward, leftward, and rightward directions by the same method as described above, and the angle at which the measured contrast was at least 10 was defined as the viewing angle.

Unevenness: The level at which unevenness was able to be visually observed was indicated by the mark “x”, while the level at which unevenness was not able to be visually observed was indicated by the mark “o.”

TABLE 2

| | Front | Viewing Angle (Degree) | | | | |
|---|---|---|---|---|---|---|
| | Contrast | Upward | Downward | Leftward | Rightward | Unevenness |
| Example 1 | 98 | 64 | 83 | 83 | 84 | ∘ |
| Example 2 | 97 | 62 | 81 | 81 | 82 | ∘ |
| Comparative | 93 | 62 | 80 | 80 | 80 | x |
| Example 1 | | | | | | |
| Comparative | 92 | 60 | 78 | 78 | 78 | x |
| Example 2 | | | | | | |
| Comparative | 75 | 54 | 62 | 67 | 69 | ∘ |
| Example 3 | | | | | | |
| Comparative | 80 | 53 | 60 | 66 | 67 | x |
| Example 4 | | | | | | |

The results of Table 2 indicate that the front contrast and each viewing angle property in each of Examples 1 and 2, and Comparative Examples 1 and 2, using an optically-compensated elliptically-polarizing plate were significantly improved as compared with those in each of Comparative Examples 3 and 4 without optical compensation. It was also demonstrated that the front contrast and each viewing angle property in each of Examples 1 and 2 with the laminated complex type scattering-dichroic absorbing polarizer were further improved as compared with those in each of Comparative Examples 1 and 2 with a conventional polarizer.

When white viewing was displayed, the brightness in each of Examples 1 and 2 and Comparative Example 3 with the laminated complex type scattering-dichroic absorbing polarizer was significantly improved as compared with that in each of Comparative Examples 1, 2 and 4 with a conventional polarizer.

The level of unevenness was determined when black viewing was displayed. As a result, no unevenness was visually observed in each of Examples 1 and 2 and Comparative Example 3 with the laminated complex type scattering-dichroic absorbing polarizer, and each of Examples 1 and 2 and Comparative Example 3 exhibited good visibility, in contrast to each of Comparative Examples 1, 2 and 4 with a conventional polarizer.

As a complex type scattering-dichroic absorbing polarizer having a similar structure as a structure of a polarizer of this invention, a polarizer in which a mixed phase of a liquid crystalline birefringent material and an absorption dichroism material is dispersed in a resin matrix is disclosed in Japanese Patent Laid-Open No. 2002-207118, whose effect is similar as that of this invention. However, as compared with a case where an absorption dichroism material exists in dispersed phase as in Japanese Patent Laid-Open No. 2002-207118, since in a case where an absorption dichroism material exists in a matrix layer as in this invention a longer optical path length may be realized by which a scattered polarized light passes absorption layer, more scattered light may be absorbed. Therefore, this invention may demonstrate much higher effect of improvement in light polarizing performance. This invention may be realized with simple manufacturing process.

Although an optical system to which a dichroic dye is added to either of continuous phase or dispersed phase is disclosed in Japanese Patent Laid-Open No. 2000-506990, this invention has large special feature in a point of laminating a complex type absorbing polarizer, the transparent support and the optically anisotropic layer comprising a discotic or nematic liquid crystal whose molecule has an optical axis tilted with respect to a surface of the transparent support, especially this invention has large special feature in a point of using iodine as an absorption dichroism material of the complex type absorbing polarizer. The following advantages are realized when using not dichroic dye but iodine. (1) Absorption dichroism demonstrated with iodine is higher than by dichroic dye. Therefore, polarized light characteristics will also become higher if iodine is used for a polarizer obtained. (2) Iodine does not show absorption dichroism, before being added in a continuous phase (matrix phase), and after being dispersed in a matrix, an iodine based light absorbing material showing dichroism is formed by stretching. This point is different from a dichroic dye having dichroism before being added in a continuous phase. That is, iodine exists as iodine itself, when dispersed in a matrix. In this case, in general, iodine has a far effective diffusibility in a matrix compared with a dichroic dye. As a result, iodine based light absorbing material is dispersed to all corners of a film more excellently than dichroic dye. Therefore, an effect of increasing optical path length by scattering anisotropy can be utilized for maximum, which increases polarized light function.

A background of invention given in Japanese Patent Laid-Open No. 2000-506990 describes that optical property of a stretched film in which liquid droplets of a liquid crystal are arranged in a polymer matrix is indicated by Aphonin et al. However, Aphonin et al. has mentioned an optical film comprising a matrix phase and a dispersed phase (liquid crystal component), without using a dichroic dye, and since a liquid crystal component is not a liquid crystal polymer or a polymerized liquid crystal monomer, a liquid crystal component in the film concerned has a sensitive birefringence typically depending on temperatures. On the other hand, this invention provides a polarizer comprising a film having a structure where minute domains are dispersed in a matrix formed of an optically-transparent water-soluble resin including an iodine based light absorbing material, furthermore, in a liquid crystalline material of this invention, in the case of a liquid crystal polymer, after it is orientated in a liquid crystal temperature range, cooled to room temperatures and thus orientation is fixed, in the case of a liquid crystal monomer, similarly, after orientation, the orientation is fixed by ultraviolet curing etc., birefringence of minute domains formed by a liquid crystalline material does not change by the change of temperatures.

### INDUSTRIAL APPLICABILITY

The elliptically polarizing plate of the invention or the optical film using thereof is suitable for image displays such as liquid crystal displays, organic EL displays, CRTs, and PDPs.

1. An elliptically polarizing plate, comprising:
a complex type scattering-dichroic absorbing polarizer including a monolayer film that has a structure having a minute domain dispersed in a matrix formed of an optically-transparent water-soluble resin including an iodine based light absorbing material;
a transparent support; and
an optically anisotropic layer comprising a discotic or nematic liquid crystal, wherein the molecule of the liquid crystal has an optical axis tilted with respect to a surface of the transparent support.

2. The elliptically polarizing plate according to claim 1, wherein the minute domain of the complex type absorbing polarizer is formed of an oriented birefringent material.

3. The elliptically polarizing plate according to claim 2, wherein the birefringent material shows liquid crystalline at least in orientation processing step.

4. The elliptically polarizing plate according to claim 2, wherein the minute domain of the complex type absorbing polarizer has 0.02 or more of birefringence.

5. The elliptically polarizing plate according to claim 2, wherein in a refractive index difference between the birefringent material forming the minute domain and the optically-transparent water-soluble resin of the complex type absorbing polarizer in each optical axis direction,
a refractive index difference (Δn¹)in direction of axis showing a maximum is 0.03 or more, and
a refractive index difference (Δn²) between the Δn¹ direction and a direction of axes of two directions perpendicular to the Δn¹ direction is 50% or less of the Δn¹.

6. The elliptically polarizing plate according to claim 5, wherein an absorption axis of the iodine based light absorbing material of the complex type absorbing polarizer is oriented in the Δn¹ direction.

7. The elliptically polarizing plate according to claim 1, wherein the film used as the complex type absorbing polarizer is manufactured by stretching.

8. The elliptically polarizing plate according to claim 5, wherein the minute domain of the complex type absorbing polarizer has a length of 0.05 to 500 μm in the Δn² direction.

9. The elliptically polarizing plate according to claim 1, wherein the complex type absorbing polarizer, the transparent support and the optically anisotropic layer comprising a discotic or nematic liquid crystal, wherein the molecule of the liquid crystal has an optical axis tilted with respect to a surface of the transparent support are laminated in this order.

10. The elliptically polarizing plate according to claim 1, wherein the complex type absorbing polarizer, the transparent support and the optically anisotropic layer comprising a discotic or nematic liquid crystal, wherein the molecule of the liquid crystal has an optical axis tilted with respect to a surface of the transparent support are laminated and fixed with a transparent acrylic pressure-sensitive adhesive.

11. The elliptically polarizing plate according to claim 1, wherein a transmittance to a linearly polarized light in a transmission direction is 80% or more,
a haze value is 5% or less, and
a haze value to a linearly polarized light in an absorption direction is 30% or more, with regard to the complex type absorbing polarizer.

12. An optical film comprising at least one of the elliptically polarizing plate according to claim 1.

13. An image display comprising the elliptically polarizing plate according to claim 1.

14. An image display comprising the optical film according to claim 12.
